(19) United States
(12) Patent Application Publication
(10) Pub. No.: US 2014/0349240 A1
(43) Pub. Date: Nov. 27, 2014

(54) HEAT TREATMENT FURNACE

(71) Applicant: Tsuyoshi Kajitani, Osaka-shi (JP)

(72) Inventor: Tsuyoshi Kajitani, Osaka-shi (JP)

(73) Assignee: SHOEI MFG. CO., LTD., Osaka-shi, Osaka (JP)

(21) Appl. No.: 13/810,300

(22) PCT Filed: Feb. 8, 2012
(86) PCT No.: PCT/JP2012/052880

§ 371 Date: Mar. 18, 2013

(51) Int. Cl. F27D 7/04; F27B 17/00

(52) U.S. Cl. CPC F27D 7/04; F27B 17/00
USPC 432/202

(57) ABSTRACT

The heat transfer efficiency is improved.

A heat treatment furnace includes a furnace body 10, a hearth 12, a blowing apparatus 14, a wind passing member 16, a heating apparatus 18, and a rack 20. The furnace body 10 has a doored opening 36. The wind passing member 16 has a cylindrical portion and wind guiding portions. The cylindrical portion has an entrance port and rack-opposing flow-out ports. Wind enters through the entrance port. The rack-opposing flow-out ports are opposed to the rack 20. Wind flows out from the rack-opposing flow-out ports. The wind guiding portions are attached to the cylindrical portion. The wind guiding portions block part of the wind which flows along the inner circumferential surface of the cylindrical portion, to guide the wind to the rack-opposing flow-out ports.

### TECHNICAL FIELD

The present invention relates to a heat treatment furnace, and more particularly to a heat treatment furnace in which the heat transfer efficiency can be improved.

### BACKGROUND ART

Patent Literature 1 discloses a hot air circulating furnace. The hot air circulating furnace includes: a furnace body having a heat source and a rotary hearth; an annular mounting table; an axial fan; and an annular partition. The mounting table is disposed along the peripheral wall of the furnace body in a portion which is close to the outer circumferential side of the rotary hearth. Workpieces are placed on the mounting table so as to be loadable/unloadable in a radial direction. A circulating flow can vertically pass through the mounting table. The axial fan is disposed in the vicinity of the ceiling of the furnace body. The axial fan sucks hot gas from its outer circumferential direction toward a center portion, and ejects the hot gas toward the rotary hearth. The annular partition divides the interior of the furnace into an outer circumferential region, and an inner region which is inside the outer circumferential region. The annular partition defines a passage in which the circulating flow is reversed in the vicinities of the rotary hearth and the ceiling in the furnace body. According to the hot air circulating furnace described in Patent Literature 1, the amount of throughput can be increased although the size is small.

The hot air circulating furnace disclosed in Patent Literature 1 has a problem in that dispersion in quality easily occurs between a workpiece accommodated in an upper portion of the mounting table and that accommodated in a lower portion. In order to solve the problem, a hot air circulating furnace disclosed in Patent Literature 2 has a plurality of workpiece accommodating chambers which are placed in a doughnut-like shape. Each of the workpiece accommodating chambers is configured so that hot air which is blown to the center of the doughnut-like shape flows in from the side of the center of the doughnut-like shape, and is discharged to the outside of the doughnut-like shape. According to the hot air circulating furnace described in Patent Literature 2, even when a plurality of workpieces are accommodated in any step of the workpiece mounting table, the workpieces can undergo heat treatment under uniform conditions.

### PRIOR ART LITERATURE

### Patent Literature

Patent Literature 1: Japanese Patent Application Laid-Open No. 2004-257658
Patent Literature 2: Japanese Patent Application Laid-Open No. 2008-138916

### SUMMARY OF THE INVENTION

### Problem to be Solved by the Invention

However, the hot air circulating furnace described in Patent Literature 2 has a problem in that there is room for improvement in heat transfer efficiency.

The invention has been conducted in order to solve the problem. It is an object of the invention to provide a heat treatment furnace in which the heat transfer efficiency can be improved.

### Means for Solving the Problem

The heat treatment furnace of the invention will be described with reference to the drawings. In the column, the use of the reference numerals in the figures is intended to facilitate understanding of the contents of the invention, and is not intended to limit the contents to the illustrated range.

According to a certain aspect of the invention, a heat treatment furnace includes a furnace body 10, a hearth 12, a blowing apparatus 14, a wind passing member 16, a heating apparatus 18, and a rack 20. The furnace body 10 has doored openings 36, 38. The hearth 12 is opposed to the interior of the furnace body 10. The blowing apparatus 14 is placed inside the furnace body 10. The blowing apparatus 14 takes in the gas in the furnace body 10, and blows wind. The wind passing member 16 is placed inside the furnace body 10. The wind passing member 16 is opposed to the blowing apparatus 14. Wind passes through the wind passing member 16. The heating apparatus 18 is placed inside the furnace body 10. The heating apparatus 18 heats at least one of the gas taken in by the blowing apparatus 14, and wind which has not yet entered the wind passing member 16. The rack 20 is placed inside the furnace body 10 and in the circumference of the wind passing member 16. The rack 20 rotates around the wind passing member 16. The wind passing member 16 has a cylindrical portion 50 and wind guiding portions 52, 54. The cylindrical portion 50 has an entrance port 60 and rack-opposing flow-out ports 64, 66, 68, 70, 72, 74. Wind enters through the entrance port 60. The rack-opposing flow-out ports 64, 66, 68, 70, 72, 74 are opposed to the rack 20. Wind flows out from the rack-opposing flow-out ports 64, 66, 68, 70, 72, 74. The wind guiding portions 52, 54 are attached to the cylindrical portion 50. The wind guiding portions 52, 54 block part of the wind which flows along the inner circumferential surface of the cylindrical portion 50, to guide the wind to the rack-opposing flow-out ports 64, 66, 68, 70, 72, 74.

The heating apparatus 18 heats at least one of the gas taken in by the blowing apparatus 14, and wind which has not yet entered the wind passing member 16. The blowing apparatus 14 takes in a gas in the furnace body 10 to blow wind. The wind which has been heated by the heating apparatus 18 passes through the wind passing member 16. The wind guiding portions 52, 54 of the wind passing member 16 block part of wind which flows along the inner circumferential surface of the cylindrical portion 50, to guide the wind to the rack-opposing flow-out ports 64, 66, 68, 70, 72, 74. The wind which has been guided by the wind guiding portions 52, 54 to the rack-opposing flow-out ports 64, 66, 68, 70, 72, 74, and which exits therefrom to the outside of the cylindrical portion 50 becomes wind which is higher in velocity than wind that is spontaneously ejected by the atmospheric pressure from the flow-out ports 64, 66, 68, 70, 72, 74 to the outside of the cylindrical portion 50. Since the velocity of the wind is high, the heat transfer efficiency of the wind can be improved.

Preferably, the wind guiding portions 52 have a wind receiving surface 90 and an outlet inner surface 92. In this case, the wind receiving surface 90 receives wind. The outlet inner surface 92 contacts with the wind receiving surface 90. At least a part of the wind receiving surface 90 is placed inside the cylindrical portion 50. At least a part of the outlet inner surface 92 is placed inside the rack-opposing flow-out port 64, 66, 68, 70, 72, 74.

At least a part of the wind receiving surface 90 is placed inside the cylindrical portion 50. The wind receiving surface 90 receives wind. The outlet inner surface 92 contacts with the wind receiving surface 90. At least a part of the outlet inner surface 92 is placed inside the rack-opposing flow-out port 64, 66, 68, 70, 72, 74. According to the configuration, the resistance which the wind receives when the wind passes through the rack-opposing flow-out ports 64, 66, 68, 70, 72, 74 is reduced as compared to the case where the outlet inner surface 92 does not contact with the wind receiving surface 90. In an example of the case where the outlet inner surface 92 does not contact with the wind receiving surface 90, there are cases where a step exists between the outlet inner surface 92 and the wind receiving surface 90, and where gaps exist between the rack-opposing flow-out ports 64, 66, 68, 70, 72, 74 and the wind guiding portions 52. When the resistance which the wind receives is reduced, the velocity of the wind which is guided to the rack-opposing flow-out ports 64, 66, 68, 70, 72, 74, and which exits therefrom to the outside of the cylindrical portion 50 becomes higher as compared to the case where the resistance is high. Since the velocity is high, the heat transfer efficiency of the wind is improved. The structure in which a part of the outlet inner surface 92 is placed inside the rack-opposing flow-out ports 64, 66, 68, 70, 72, 74 can be realized more easily than that described below. The structure is a structure in which the wind guiding portions 54 are attached to the cylindrical portion 50 so that wind receiving surfaces 94 of the wind guiding portions 54 contact with the inner circumferential surfaces of the rack-opposing flow-out ports 64, 66, 68, 70, 72, 74.

Alternatively preferably, an end of the above-described outlet inner surface 92 reaches the outside of the cylindrical portion 50.

In the case where the end of the above-described outlet inner surface 92 reaches the outside of the cylindrical portion 50, the wind which exits to the outside of the cylindrical portion 50 flows more easily along the outlet inner surface 92 until the wind reaches the end of the outlet inner surface 92, as compared to the case where such a structure is not formed. Since the wind easily flows along the outlet inner surface 92, the amount of wind which flows between the outer circumferential surface of the cylindrical portion 50 and the rack 20 can be suppressed as compared to the case where the end does not reach the outside of the cylindrical portion 50. Because the amount of wind which flows there can be suppressed, the heat loss due to flowing of wind therethrough can be suppressed.

Preferably, the above-described wind guiding portions 54 have a wind receiving surface 94. The wind receiving surfaces 94 are placed inside the cylindrical portion 50. The wind receiving surfaces 94 receive wind. The wind receiving surfaces 94 contact with the inner circumferential surfaces of the rack-opposing flow-out ports 64, 66, 68, 70, 72, 74.

In the case where the wind receiving surfaces 94 contact with the inner circumferential surfaces of the rack-opposing flow-out ports 64, 66, 68, 70, 72, 74, the resistance which wind receives in the below-described occasion is reduced as compared to the case where the wind receiving surfaces 94 do not contact with the inner circumferential surfaces of the rack-opposing flow-out ports 64, 66, 68, 70, 72, 74. The occasion is an occasion when wind passes through the rack-opposing flow-out ports 64, 66, 68, 70, 72, 74. In an example of the case where the wind receiving surfaces 94 do not contact with the inner circumferential surfaces of the rack-opposing flow-out ports 64, 66, 68, 70, 72, 74, there are cases where steps exist between the inner circumferential surfaces of the rack-opposing flow-out ports 64, 66, 68, 70, 72, 74 and the wind receiving surfaces 94, and where gaps exist between the rack-opposing flow-out ports 64, 66, 68, 70, 72, 74 and the wind guiding portions 52. Since the resistance is low, the velocity of the wind which is guided to the rack-opposing flow-out ports 64, 66, 68, 70, 72, 74, and which exits therefrom to the outside of the cylindrical portion 50 becomes higher as compared to the case where the resistance is high. Since the velocity is high, the heat transfer efficiency of the wind is improved.

Preferably, the above-described rack 20 has a plurality of rack plates 30. The rack plates 30 are placed so as to constitute a layered structure. The rack plates 30 have air permeability. In this case, the cylindrical portion 50 has a plurality of rack-opposing flow-out ports 64, 66, 68, 70, 72, 74. The cylindrical portion 50 further has a hearth-opposing flow-out port 62. The wind passing member 16 has the above-described plurality of wind guiding portions. The plurality of rack-opposing flow-out ports 64, 66, 68, 70, 72, 74 are placed so as to be arranged in the layered direction of the rack plates 30. The hearth-opposing flow-out port 62 is opposed to the hearth 12 through a gap. Among the plurality of rack plates 30, the rack plate 30 which is closest to the hearth 12 is opposed to the hearth 12.

When the heat treatment furnace of the invention is placed so that the furnace body 10 is in the upper side and the hearth 12 is in the lower side, wind which exits from the hearth-opposing flow-out port 62 once impinges on the hearth, then spreads, and rises along the periphery of the cylindrical portion 50. When the wind sequentially passes through the rack plates 30, the wind pushes wind exiting from the rack-opposing flow-out ports 64, 66, 68, 70, 72, 74. In the case where the wind exiting from the rack-opposing flow-out ports 64, 66, 68, 70, 72, 74 is pushed, the wind exiting from the rack-opposing flow-out ports 64, 66, 68, 70, 72, 74 can be suppressed from spreading to the outer circumference of the rack 20 as compared to the case where such a structure is not formed. Since the wind is suppressed from spreading to the outer circumference of the rack 20, the heat loss due to a phenomenon in which the wind spreading to the outer circumference of the rack 20 circulates in-situ in the furnace body 10 can be suppressed. Moreover, the cylindrical portion 50 has the hearth-opposing flow-out port 62, whereby stagnation of gas in the wind passing member 16 can be suppressed as compared to the case where the cylindrical portion does not have the hearth-opposing flow-out port 62. Since stagnation of gas can be suppressed, the loss of the heat of the gas can be suppressed.

Alternatively preferably, one of the above-described rack-opposing flow-out ports 64, 66, 68, 70, 72, 74 is placed at a position where the following two requirements are satisfied. The first requirement is that the position is between rack plates 30 which are adjacent to each other. The second requirement is that the position is closer to the rack plate 30 of the rack plates 30 which are adjacent to each other, the rack plate being remoter from the hearth 12, than the rack 30 that is closer to the hearth 12.

When the heat treatment furnace of the invention is placed so that the furnace body 10 is in the upper side and the hearth 12 is in the lower side, wind which exits from the rack-opposing flow-out ports 64, 66, 68, 70, 72, 74 impinges on articles mounted on the rack plates 30 from the lower side. Since heated gas tends to rise, heat is transferred to an article more easily by blowing in which wind impinges on the article from the lower side, than by that in which wind laterally impinges on the article. Since heat is easily transferred, the heat loss can be correspondingly easily suppressed.

Alternatively preferably, one of the above-described rack-opposing flow-out ports 64, 66, 68, 70, 72, 74 satisfies the following two requirements. The first requirement is that the distance between the flow-out port and the blowing apparatus 14 is shorter than that between a contrast object flow-out port which is one of the other rack-opposing flow-out ports 64, 66, 68, 70, 72, 74, and the blowing apparatus. The second requirement is that the flow-out port is smaller than the contrast object flow-out port.

The flow amount of wind from the rack-opposing flow-out ports 64, 66, 68, 70, 72, 74 in which these requirements are satisfied is smaller than that from the contrast object flow-out port. By contrast, the flow amount of wind from the rack-opposing flow-out ports 64, 66, 68, 70, 72, 74 in which the distance from the blowing apparatus 14 is short is larger than that from the rack-opposing flow-out ports 64, 66, 68, 70, 72, 74 in which the distance from the blowing apparatus 14 is long. The smallness causes the flow amount to be reduced, and the short distance from the blowing apparatus 14 causes the flow amount to be increased. The difference of the flow amount due to the distance from the blowing apparatus 14 can be compensated. Since the difference of the flow amount can be compensated, also the difference of the amount of heat can be compensated. Since the difference of the amount of heat can be compensated, heat treatment conditions on articles mounted on the rack 30 can be made more uniform.

### Effect of the Invention

As described above, in the heat treatment furnace of the invention, the heat transfer efficiency can be improved.

### BRIEF DESCRIPTION OF THE DRAWINGS

FIG. 1 is a vertical sectional view of a heat treatment furnace of an embodiment of the invention.

FIG. 2 is a view showing the configuration of a rack in the embodiment of the invention.

FIG. 3 is a horizontal sectional view of the heat treatment furnace of the embodiment of the invention.

FIG. 4 is a view showing the configuration of a wind passing member in the embodiment of the invention.

FIG. 5 is a vertical sectional view of a part of the heat treatment furnace of the embodiment of the invention.

FIG. 6 is a perspective view of a wind guiding portion in the embodiment of the invention.

FIG. 7 is a perspective view of a wind guiding portion in a modification of the invention.

### MODE FOR CARRYING OUT THE INVENTION

Hereinafter, an embodiment of the invention will be described with reference to the drawing. In the following description, the identical components are denoted by the same reference numerals. Also their names and functions are identical. Therefore, their detailed description is not repeated.

### [Description of Configuration]

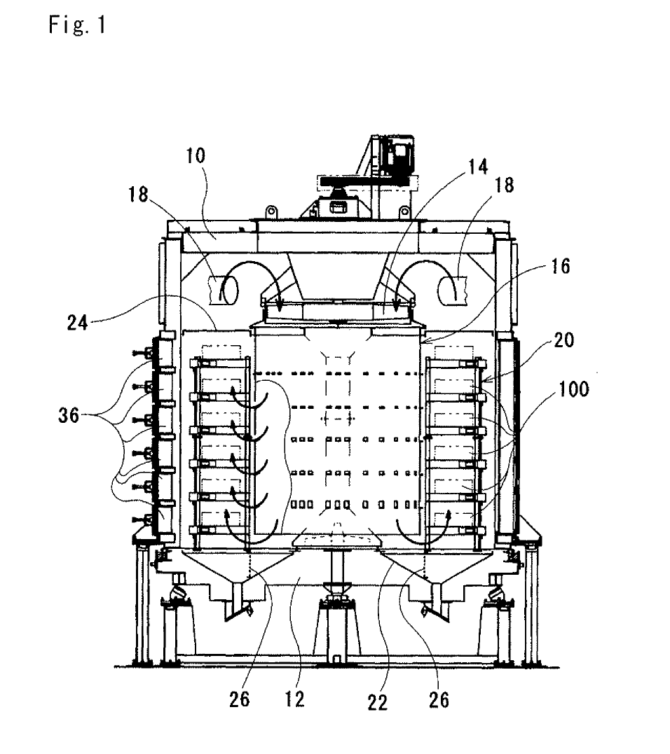

Referring to FIG. 1, the configuration of a heat treatment furnace of the embodiment will be described. The heat treatment furnace of the embodiment includes a furnace body 10, a hearth 12, a blowing apparatus 14, a wind passing member 16, a heating apparatus 18, a rack 20, a sand removal chute 22, and a distributing member 24.

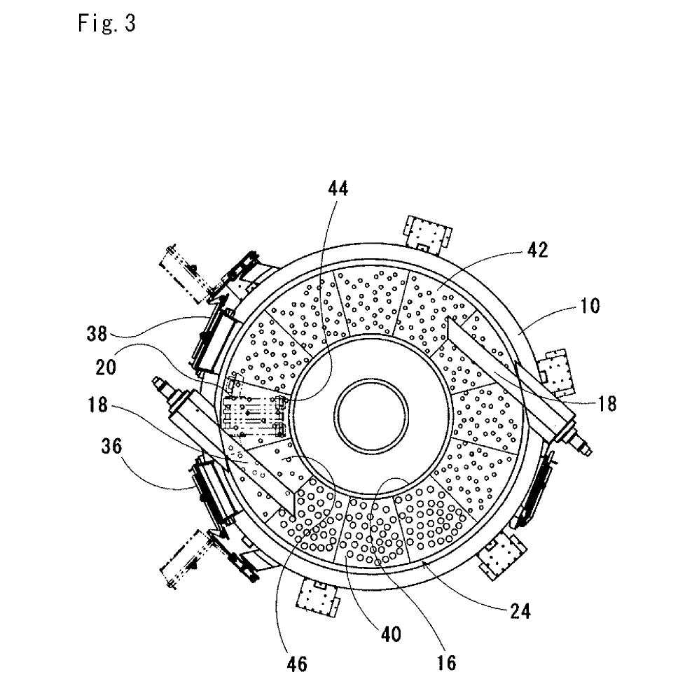

The furnace body 10 has doored openings. In the embodiment, one kind of the openings is an inlet opening 36. The other kind of the openings is an outlet opening 38 shown in FIG. 3.

The hearth 12 is placed below the furnace body 10 (i.e., in the direction of gravity as viewed from the furnace body 10). The hearth 12 is opposed to the interior of the furnace body 10. The hearth 12 is rotated in a horizontal direction. In the embodiment, even when the direction is not horizontal in the strict sense, however, it is assumed that the hearth 12 is rotated in a horizontal direction when the horizontal direction has an accuracy which will be described below. The accuracy is in the level at which the wind passing member 16, the distributing member 24, and the rack 20 do not collide with each other.

The blowing apparatus 14 is placed inside the furnace body 10. The blowing apparatus 14 takes in the gas (in the embodiment, air) in the furnace body 10, and blows wind. In the embodiment, an axial fan is disposed as blowing apparatus 14. The thick arrows shown in FIG. 1 indicate the flow of wind.

The wind passing member 16 is placed inside the furnace body 10. In the embodiment, the wind passing member 16 is hung inside the furnace body 10 by a member which is not shown. The wind passing member 16 is opposed to the blowing apparatus 14. The wind blown from the blowing apparatus 14 passes through the interior of the wind passing member 16. In the wind passing member 16 shown in FIG. 1, some parts are not shown.

In the embodiment, the heating apparatus 18 is placed in the circumference of the blowing apparatus 14. The heating apparatus 18 heats air which has passed through the rack 20 and risen to the apparatus. The air which has been heated by the heating apparatus 18 is taken in into the blowing apparatus 14 and then sent as wind. In the embodiment, two burners are disposed as the heating apparatus 18.

The rack 20 is placed inside the furnace body 10 and in the circumference of the wind passing member 16. The rack 20 is attached to the hearth 12, thereby causing the rack 20 to rotate around the wind passing member 16. Workpieces 100 are mounted on the rack 20.

Similarly with the rack 20, also the sand removal chute 22 is attached to the hearth 12. The sand removal chute 22 collects sand which drops off from the workpieces 100. Sand discharge ports are disposed in the bottom of the sand removal chute 22. The collected sand is discharged through the sand discharge ports.

The distributing member 24 is placed between the heating apparatus 18 and the rack 20. The distributing member 24 impedes the flow of the air which has passed through the rack 20 and risen to the member. In the embodiment, a small gap is formed between the distributing member 24 and the inner circumferential surface of the furnace body 10.

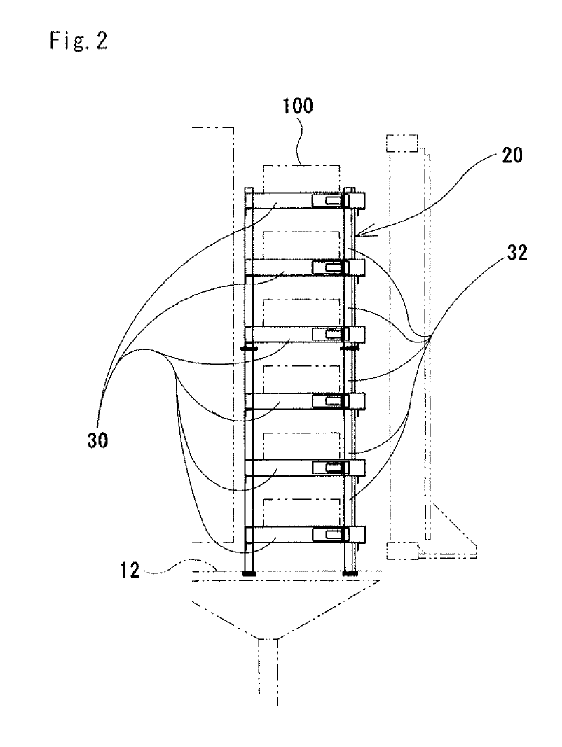

Referring to FIG. 2, the configuration of the rack 20 will be described. The rack 20 has a plurality of rack plates 30, and rack support post members 32 which support the rack plates 30. The workpieces 100 are mounted on the rack plates 30. The rack plates 30 are placed so as to constitute a layered structure. In the embodiment, the rack plates 30 are configured by arranging a plurality of square pipes in the rotation direction of the rack 20, and connecting the square pipes to one another. Since the rack plates are configured by connecting square pipes to one another, the rack plates 30 exhibit a planar structure. Since the rack plates are configured by connecting square pipes to one another, the rack plates 30 have air permeability. In the embodiment, six layers of the rack plates 30 are disposed. In the embodiment, among the plurality of rack plates 30, the rack plate 30 which is closest to the hearth 12 is opposed to the hearth 12.

Referring to FIG. 3, the distributing member 24 will be described. The distributing member 24 has a first shielding portion 40, a second shielding portion 42, a third shielding portion 44, and a fourth shielding portion 46. The first shielding portion 40 is placed on the outer circumference of the wind passing member 16 and between the heating apparatus 18 and the rack 20. The first shielding portion 40 is placed in a zone which is on the side of the rotation direction (in the embodiment, a counterclockwise direction as viewing the heat treatment furnace from the upper side) of the hearth 12 with respect to the inlet opening 36. In the embodiment, the first shielding portion 40 is configured by three plates. In these plates, large holes are opened. Also the second shielding portion 42 is placed on the outer circumference of the wind passing member 16 and between the heating apparatus 18 and the rack 20. The second shielding portion 42 is placed in a zone which will be described below. The zone is a zone continuous to the zone where the first shielding portion 40 is placed, at one of the both ends of the zone where the first shielding portion 40 is placed, the one end being on the side of the rotation direction of the hearth 12. In the embodiment, a space which is opposed to an outlet opening 38 is formed below a terminal end portion of the zone. In the embodiment, the second shielding portion 42 is configured by seven plates. In these plates, small holes are opened. In the embodiment, the number of holes per unit area in the first shielding portion 40 is equal to that in the second shielding portion 42. The sizes of the plates configuring the portions are identical with each other. In the embodiment, the first shielding portion 40 and the second shielding portion 42 are different from each other only in the size of the holes. According to the configuration, in the embodiment, the sum of opening areas in the second shielding portion 42 is smaller than that in the first shielding portion 40. Since the large holes are opened in the first shielding portion 40 and the small holes are opened in the second shielding portion 42, as compared to the zone where the first shielding portion 40 is placed, the flow of wind is impeded in the zone where the second shielding portion 42 is placed. Therefore, much hot wind is distributed to the former zone, as compared to the latter zone. Since much hot wind is distributed, the workpieces 100 which are below the first shielding portion 40 are rapidly heated.

As a result, the space below the first shielding portion 40 becomes a heating zone. The space below the second shielding portion 42 becomes a soaking zone. The third shielding portion 44 is placed in a zone which will be described below. The zone is a zone continuous to the zone where the second shielding portion 42 is placed, at one of the both ends of the zone where the second shielding portion 42 is placed, the one end being on the side of the rotation direction of the hearth 12. The space below the third shielding portion 44 corresponds to that between the inlet opening 36 and the outlet opening 38. The fourth shielding portion 46 is placed in a zone which will be described below. The zone is a zone continuous to the zone where the third shielding portion 44 is placed, at one of the both ends of the zone where the third shielding portion 44 is placed, the one end being on the side of the rotation direction of the hearth 12. The space below the fourth shielding portion 46 is a space which is opposed to the inlet opening 36. In the embodiment, the third shielding portion 44 is configured by one plate. Also the fourth shielding portion 46 is configured in a similar manner. Holes are disposed in both the third shielding portion 44 and the fourth shielding portion 46. The number of holes per unit area is a half of that in the second shielding portion 42. The size of the holes is identical with that in the second shielding portion 42. According to the structure, most portion of wind which has passed through the rack 20 is blocked by these regions. In these regions, however, the gap is disposed between the inner circumferential surface of the furnace body 10 and the distributing member 24. Since the gap is formed, part of the wind which rises from the hearth 12 passes through the gap.

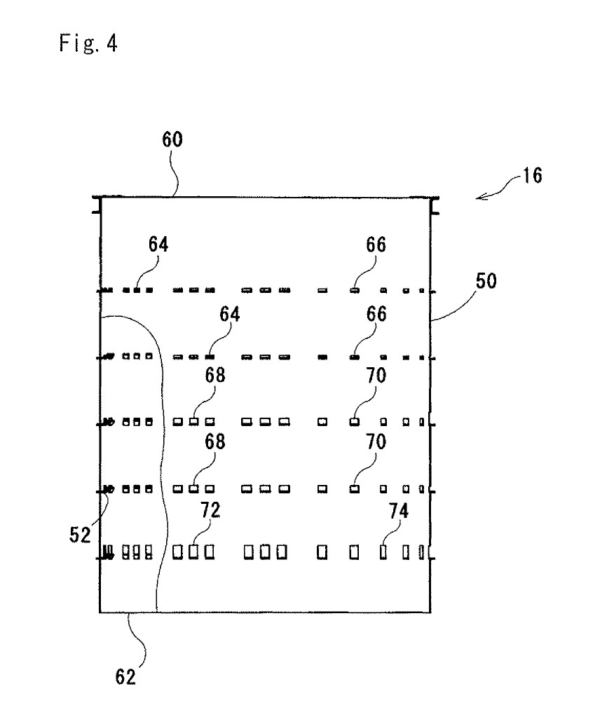

Referring to FIG. 4, the configuration of the wind passing member 16 will be described. The wind passing member 16 has a cylindrical portion 50 and a plurality of wind guiding portions 52. In the embodiment, the cylindrical portion 50 is a circular cylindrical member. The cylindrical portion 50 has an entrance port 60, a hearth-opposing flow-out port 62, upper-heating zone rack-opposing flow-out ports 64, upper-soaking zone rack-opposing flow-out ports 66, middle-heating zone rack-opposing flow-out ports 68, middle-soaking zone rack-opposing flow-out ports 70, lower-heating zone rack-opposing flow-out ports 72, and lower-soaking zone rack-opposing flow-out ports 74. In the embodiment, the upper-heating zone rack-opposing flow-out ports 64, the upper-soaking zone rack-opposing flow-out ports 66, the middle-heating zone rack-opposing flow-out ports 68, the middle-soaking zone rack-opposing flow-out ports 70, the lower-heating zone rack-opposing flow-out ports 72, and the lower-soaking zone rack-opposing flow-out ports 74 are generally referred to as “rack-opposing flow-out ports”. The wind blown from the blowing apparatus 14 enters the interior of the cylindrical portion 50 through the entrance port 60. The rack-opposing flow-out ports are opposed to the rack 20. Part of the wind flowing through the cylindrical portion 50 flows out to the outside of the cylindrical portion 50 via the rack-opposing flow-out ports. The remaining part of the wind flowing through the cylindrical portion 50 flows out to the outside of the cylindrical portion 50 via the hearth-opposing flow-out port 62. In the embodiment, the wind guiding portions 52 are disposed respectively in all the rack-opposing flow-out ports. This results in that the wind guiding portions 52 are disposed on the cylindrical portion 50. Each of the wind guiding portions 52 blocks part of the wind flowing along the inner circumferential surface of the cylindrical portion 50, and guides it to the rack-opposing flow-out ports. Part of the wind guided by the wind guiding portion 52 exits to the outside of the cylindrical portion 50 via the rack-opposing flow-out port in which the wind guiding portion 52 is disposed. In the wind passing member 16 shown in FIG. 4, some parts are not shown. The interior of the wind passing member 16 appears in the area where the parts are not shown.

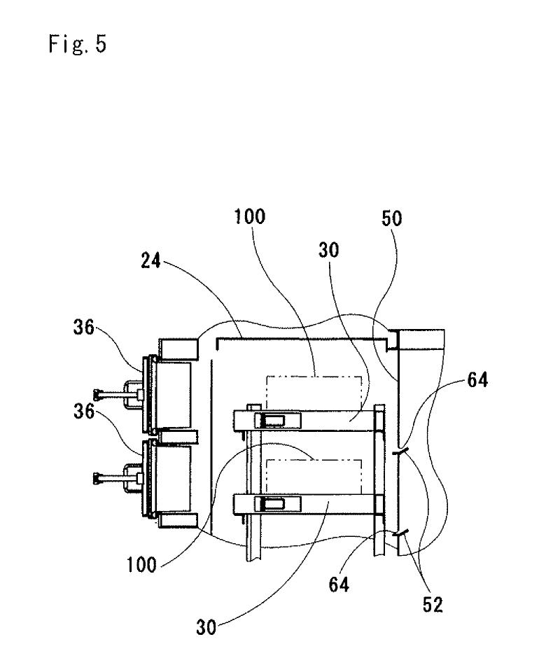

In the embodiment, the upper-heating zone rack-opposing flow-out ports 64 are placed at positions where the following two requirements are satisfied. The first requirement is that the positions are immediately below the rack plate 30 of the highest layer in the rack plates 30 of the rack 20, or immediately below the rack plate 30 of the second-highest layer. The second requirement is that the positions are opposed to the above-described heating zone (in the embodiment, the space below the first shielding portion 40). FIG. 5 is a sectional view of the heat treatment furnace of the embodiment, with respect to the vicinity of the upper-heating zone rack-opposing flow-out ports 64. FIG. 5 shows that the upper-heating zone rack-opposing flow-out ports 64 are disposed immediately below the rack plate 30 of the highest layer or immediately below the rack plate 30 of the second-highest layer.

In the embodiment, the upper-soaking zone rack-opposing flow-out ports 66 are placed at positions where the following two requirements are satisfied. The first requirement is that the positions are immediately below the rack plate 30 of the highest layer in the rack plates 30 of the rack 20, or immediately below the rack plate 30 of the second-highest layer. The second requirement is that the positions are opposed to the above-described soaking zone (in the embodiment, the space below the second shielding portion 42).

In the embodiment, the middle-heating zone rack-opposing flow-out ports 68 are placed at positions where the following two requirements are satisfied. The first requirement is that the positions are immediately below the rack plate 30 of the third-highest layer in the rack plates 30 of the rack 20, or immediately below the rack plate 30 of the fourth-highest layer. The second requirement is that the positions are opposed to the above-described heating zone.

In the embodiment, the middle-soaking zone rack-opposing flow-out ports 70 are placed at positions where the following two requirements are satisfied. The first requirement is that the positions are immediately below the rack plate 30 of the third-highest layer in the rack plates 30 of the rack 20, or immediately below the rack plate 30 of the fourth-highest layer. The second requirement is that the positions are opposed to the above-described soaking zone.

In the embodiment, the lower-heating zone rack-opposing flow-out ports 72 are placed at positions where the following two requirements are satisfied. The first requirement is that the positions are immediately below the rack plate 30 of the fifth-highest layer in the rack plates 30 of the rack 20. The second requirement is that the positions are opposed to the above-described heating zone.

In the embodiment, the lower-soaking zone rack-opposing flow-out ports 74 are placed at positions where the following two requirements are satisfied. The first requirement is that the positions are immediately below the rack plate 30 of the fifth-highest layer in the rack plates 30 of the rack 20. The second requirement is that the positions are opposed to the above-described soaking zone.

In the embodiment, the upper-heating zone rack-opposing flow-out ports 64 and the upper-soaking zone rack-opposing flow-out ports 66 are disposed in a plural number. The upper-heating zone rack-opposing flow-out ports 64 and the upper-soaking zone rack-opposing flow-out ports 66 are identical in size with each other. The gap between the upper-heating zone rack-opposing flow-out ports 64 is narrower than that between the upper-soaking zone rack-opposing flow-out ports 66.

In the embodiment, the middle-heating zone rack-opposing flow-out ports 68 and the middle-soaking zone rack-opposing flow-out ports 70 are disposed in a plural number. The middle-heating zone rack-opposing flow-out ports 68 and the middle-soaking zone rack-opposing flow-out ports 70 are identical in size with each other. The gap between the middle-heating zone rack-opposing flow-out ports 68 is narrower than that between the middle-soaking zone rack-opposing flow-out ports 70.

In the embodiment, the lower-heating zone rack-opposing flow-out ports 72 and the lower-soaking zone rack-opposing flow-out ports 74 are disposed in a plural number. The lower-heating zone rack-opposing flow-out ports 72 and the lower-soaking zone rack-opposing flow-out ports 74 are identical in size with each other. The gap between the lower-heating zone rack-opposing flow-out ports 72 is narrower than that between the lower-soaking zone rack-opposing flow-out ports 74.

In the embodiment, the upper-heating zone rack-opposing flow-out ports 64 are smaller than the middle-heating zone rack-opposing flow-out ports 68. The middle-heating zone rack-opposing flow-out ports 68 are smaller than the lower-heating zone rack-opposing flow-out ports 72. The upper-soaking zone rack-opposing flow-out ports 66 are smaller than the middle-soaking zone rack-opposing flow-out ports 70. The middle-soaking zone rack-opposing flow-out ports 70 are smaller than the lower-soaking zone rack-opposing flow-out ports 74. In the embodiment, these rack-opposing flow-out ports have the same width. The heights of these rack-opposing flow-out ports are different from each other, and hence the sizes of these rack-opposing flow-out ports are different from each other. In the embodiment, therefore, the same wind guiding portions can be disposed with respect to these rack-opposing flow-out ports, respectively.

As apparent from the above description, in the embodiment, the following two requirements are satisfied with respect to a part of the plurality of rack-opposing flow-out ports. The first requirement is that the distance between the flow-out port and the blowing apparatus 14 is shorter than that between a contrast object flow-out port which is the other rack-opposing flow-out ports and the blowing apparatus. The second requirement is that the flow-out port is smaller than the contrast object flow-out port.

As apparent from the above description, in the embodiment, the gaps between the rack-opposing flow-out ports are different depending on to which one of the heating zone and the soaking zone the flow-out ports are opposed. The gap of the former (the rack-opposing flow-out ports which are opposed to the heating zone) is narrower than that of the latter (the rack-opposing flow-out ports which are opposed to the soaking zone).

As apparent from the above description, in the embodiment, the rack-opposing flow-out ports are placed at positions where the following two requirements are satisfied. The first one of the requirement is that the positions are between rack plates 30 which are adjacent to each other. The second one of the requirement is that the positions are closer to the rack plate 30 of the rack plates 30 which are adjacent to each other, the rack plate being remoter from the hearth 12, than the rack 30 that is closer to the hearth 12.

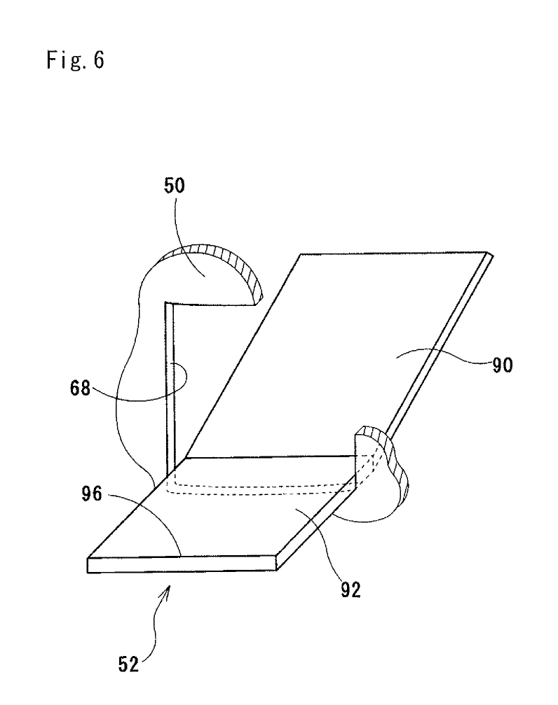

Referring to FIG. 6, the wind guiding portion 52 will be described. As seen from FIG. 6, the wind guiding portion 52 has a wind receiving surface 90 and an outlet inner surface 92. In the embodiment, the wind receiving surface 90 is placed inside the cylindrical portion 50. The wind receiving surface 90 receives the wind blown by the blowing apparatus 14. The wind receiving surface 90 is inclined toward the entrance port 60 for wind, as viewed from the hearth 12. The outlet inner surface 92 contacts with the wind receiving surface 90. A part of the outlet inner surface 92 is placed in a rack-opposing flow-out port (in FIG. 6, the middle-heating zone rack-opposing flow-out ports 68). The remaining part of the outlet inner surface 92 (then, an external projecting end 96 which is an end of the surface) reaches the outside of the cylindrical portion 50 through the outer circumferential surface of the cylindrical portion 50.

### [Description of Use Method]

A method of using the heat treatment furnace of the embodiment will be described based on the above-described configuration. The hearth 12, the blowing apparatus 14, and the heating apparatus 18 are operated. When the temperature of the interior of the furnace body 10 reaches a temperature which is suitable for heat treatment for the workpieces 100, the worker opens the door of the inlet opening 36. The “temperature which is suitable for heat treatment” is a temperature which is appropriately determined by a person in accordance with the material quality of the workpieces 100 and heat treatment to be applied on the workpieces 100. The temperature of the interior of the furnace body 10 is measured by a thermometer which is not shown. When the door of the inlet opening 36 is opened, the worker loads the workpieces 100 from the outside of the heat treatment furnace into the furnace body 10, by using an adequate jig.

When the workpieces 100 are loaded, the worker closes the door of the inlet opening 36. In the embodiment, the hearth 12 is rotated in a counterclockwise direction as viewing the heat treatment furnace from the upper side. When the hearth 12 is rotated, also the rack 20 is rotated. When the rack 20 is rotated, also the workpieces 100 mounted thereon are rotated. Therefore, the workpieces 100 are sequentially moved from the heating zone to the soaking zone.

In the heating zone, much hot air impinges on the workpieces 100. This causes the workpieces 100 to be rapidly heated. When passed through the heating zone, the workpieces 100 enter the soaking zone. In the soaking zone, the temperature is maintained substantially constant.

When the rack 20 thereafter makes one rotation, the worker opens the door of the outlet opening 38. When the door of the outlet opening 38 is opened, the worker takes out the workpieces 100 from the outlet opening 38 by using an adequate jig. Then, the heat treatment on the workpieces 100 is ended.

### [Description of Effects of the Embodiment]

As described above, according to the heat treatment furnace of the embodiment, heat treatment can be performed in one furnace. At this time, each of the wind guiding portions 52 blocks part of the wind flowing along the inner circumferential surface of the cylindrical portion 50, and guides it to the rack-opposing flow-out port. The wind which exits from the rack-opposing flow-out port to the outside of the cylindrical portion 50 heats the workpieces 100. The wind becomes wind which is higher in velocity than wind that is spontaneously ejected by the atmospheric pressure to the outside of the cylindrical portion 50. Since the velocity of the wind is high, the heat transfer efficiency of the wind can be improved.

According to the heat treatment furnace of the embodiment, moreover, the outlet inner surface 92 contacts with the wind receiving surface 90, and a part thereof is placed in the rack-opposing flow-out port. According to the configuration, the resistance which is imposed on the wind when the wind passes through the rack-opposing flow-out ports is reduced as compared to the case where the outlet inner surface 92 does not contact with the wind receiving surface 90 (the cases where a step exists between the outlet inner surface 92 and the wind receiving surface 90, and where a gap exists between the rack-opposing flow-out ports and the wind guiding portion 52). Since the resistance is low, the velocity of the wind which exits to the outside of the cylindrical portion 50 becomes higher as compared to the case where the resistance is high. Since the velocity is high, the heat transfer efficiency of the wind is improved.

According to the heat treatment furnace of the embodiment, moreover, the external projecting end 96 reaches the outside of the cylindrical portion 50. Since the end reaches the outside, wind which exits to the outside of the cylindrical portion 50 flows along the outlet inner surface 92 until the wind reaches the external projecting end 96. Since wind flows along the outlet inner surface 92, the amount of wind which flows between the outer circumferential surface of the cylindrical portion 50 and the rack 20 can be suppressed as compared to the case where the external projecting end 96 is not disposed (the end of the outlet inner surface 92 is placed inside the rack-opposing flow-out port). Because the amount of wind which flows there can be suppressed, the heat loss due to flowing of wind therethrough can be suppressed.

In the case of the heat treatment furnace of the embodiment, moreover, the hearth 12 is placed below the furnace body 10. At this time, the entrance port 60 is placed below the blowing apparatus 14. The wind passing member 16 has the hearth-opposing flow-out port 62. The hearth-opposing flow-out port 62 is disposed in the end of the cylindrical portion 50. The hearth-opposing flow-out port 62 is opposed to the hearth 12 through a gap. Therefore, part of the wind sent from the blowing apparatus 14 is exhausted toward the hearth-opposing flow-out port 62. The exhausted wind flows to the outer circumference of the wind passing member 16 through the gap between the wind passing member 16 and the hearth 12. The rack 20 has the plurality of rack plates 30. The rack plates 30 are placed so as to constitute a layered structure. The rack plates 30 have air permeability. According to the configuration, the wind flowing to the outer circumference of the wind passing member 16 rises through the interior of the furnace body 10 while passing through the rack plates 30. At this time, the wind rising through the interior of the furnace body 10 pushes up wind exiting from the rack-opposing flow-out ports. Because the wind exiting from the rack-opposing flow-out ports is pushed up, the wind exiting from the rack-opposing flow-out ports is suppressed from spreading to the outer circumference of the rack 20, as compared to the case where such a pushing up operation is not performed. Since the wind is suppressed from spreading to the outer circumference of the rack 20, the heat loss due to a phenomenon in which the wind spreading to the outer circumference of the rack 20 rises in-situ can be suppressed.

According to the heat treatment furnace of the embodiment, moreover, the rack-opposing flow-out ports are placed at positions where the following two requirements are satisfied. The first requirement is that the positions are between rack plates 30 which are adjacent to each other. The second requirement is that the positions are closer to the rack plate 30 of the rack plates 30 which are adjacent to each other, the rack plate being remoter from the hearth 12, than the rack 30 that is closer to the hearth 12. In the embodiment, the positions can be said to be below the rack plates 30. When the rack-opposing flow-out ports are placed below the rack plates 30 and the wind rising through the interior of the furnace body 10 pushes up wind exiting from the rack-opposing flow-out ports, the wind exiting from the rack-opposing flow-out ports cooperates with the wind rising through the interior of the furnace body 10 to heat the workpieces 100 from the lower side. Since air tends to rise, heat is transferred to the workpieces 100 more easily by blowing in which wind impinges on the workpieces 100 from the lower side, than by that in which wind laterally impinges on the workpieces 100. Since heat is easily transferred, the heat loss can be correspondingly easily suppressed.

In the heat treatment furnace of the embodiment, a sand removal plate 26 is attached to the interior of the sand removal chute 22. Because the sand removal plate 26 is attached to the interior of the sand removal chute 22, even in the case where a foreign material such as foundry sand remains on the workpieces 100, the foreign material is removed from the wind circulating through the interior of the furnace body 10. Since a foreign material is removed, the situation where the apparatuses and the like in the furnace are abraded by the foreign material is reduced.

### [Description of Modifications]

The embodiment which has been disclosed in the above is exemplarily shown in all aspects. The scope of the invention should not be limited based on the above-described embodiment. It is a matter of course that various design changes can be made within the range without departing the spirit of the invention.

For example, a heat source which is configured by an electric heater or the like in place of the burners may be disposed as the heating apparatus 18. The number of the heating apparatus 18 can be arbitrarily determined. The position of the heating apparatus 18 may be between the blowing apparatus 14 and the cylindrical portion 50. The heating apparatus 18 may be disposed in both the position and the periphery of the blowing apparatus 14.

Furthermore, the distributing member 24 may have slits in place of the holes. Moreover, the first shielding portion 40 and second shielding portion 42 of the distributing member 24 may be different from each other not only in the size of the holes or the slits, but also in number thereof per unit area. The distributing member 24 may be configured by a structure such as a box in place of the plurality of plates. In this case, the members constituting the distributing member 24 may have pipes through which wind passes, in place of the holes.

Furthermore, the number of the rack plates 30 disposed in the rack 20 is not limited. Also the numbers of the inlet opening 36 and the outlet opening 38 are not particularly limited. For example, a large door may be disposed in order to enable the workpieces 100 to be taken in and out of the rack plates 30 of two layers. In this case, the number of doors is reduced. In place that the inlet opening 36 and the outlet opening 38 are disposed, a doored opening functioning as an inlet and an outlet may be disposed.

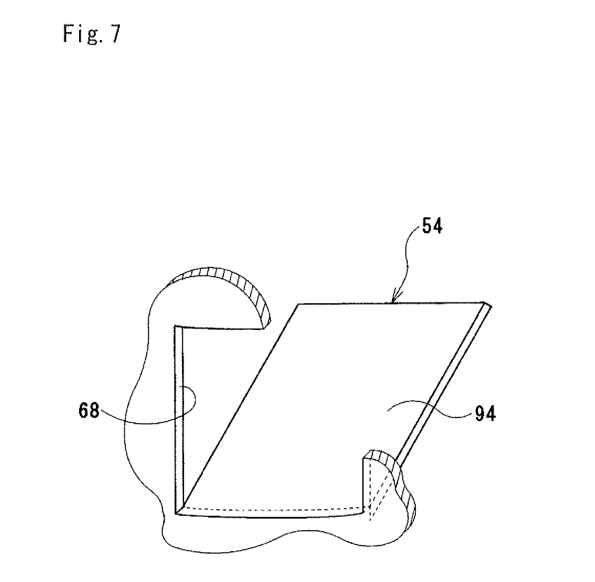

The configuration of the wind guiding portions 52 is not limited the above-described one. For example, the wind passing member 16 may have wind guiding portions 54 configured by one plate, in place of the above-described wind guiding portions 52. In the case where the wind passing member 16 has the wind guiding portions 54 configured by one plate, the wind guiding portions 54 may be preferably welded to the inner circumferential surface of the cylindrical portion 50 along the edges of the lower ends of the rack-opposing flow-out ports as shown in FIG. 7. In this case, the upper surface (the surface opposed to the entrance port 60) of the plate functions as the wind receiving surface 94 (the surface which receives wind). In this case, the wind receiving surfaces 94 contact with the inner circumferential surfaces of the rack-opposing flow-out ports. According to the configuration, wind can be smoothly guided. However, the above-described structure in which a part of the outlet inner surface 92 is placed inside the rack-opposing flow-out port is produced more easily than that in which the wind guiding portions 54 are welded to the inner circumferential surface of the cylindrical portion 50 so that the wind receiving surfaces 94 of the wind guiding portions 54 contact with the inner circumferential surfaces of the rack-opposing flow-out ports. Of course, the sizes of the wind guiding portions 52, 54 are not particularly limited. All of the wind guiding portions 52, 54 may have the same size, or sizes corresponding to the rack-opposing flow-out ports. The structures of the wind guiding portions 52, 54 may not be unified.

The relationships between the sizes and positions of the rack-opposing flow-out ports are not limited to the above-described ones. For example, all the rack-opposing flow-out ports may have the same size.

Moreover, the specific structure for placing the wind passing member 16 inside the furnace body 10 is not particularly limited.

### DESCRIPTION OF REFERENCE NUMERALS

10 furnace body
12 hearth
14 blowing apparatus
16 wind passing member
18 heating apparatus
20 rack
22 sand removal chute
24 distributing member
26 sand removal plate
30 rack plate
32 rack support post member
34 inlet opening
36 outlet opening
40 first shielding portion
42 second shielding portion
43 third shielding portion
46 fourth shielding portion
50 cylindrical portion
52, 54 wind guiding portion
60 entrance port
62 hearth-opposing flow-out port
64 upper-heating zone rack-opposing flow-out port
66 upper-soaking zone rack-opposing flow-out port
68 middle-heating zone rack-opposing flow-out port
70 middle-soaking zone rack-opposing flow-out port
72 lower-heating zone rack-opposing flow-out port
74 lower-soaking zone rack-opposing flow-out port
90, 94 wind receiving surface
92 outlet inner surface
96 external projecting end
100 workpiece

1. A heat treatment furnace having:
a furnace body having a doored opening;
a hearth which is opposed to an interior of said furnace body;
a blowing apparatus which is placed inside said furnace body, and which takes in a gas in the furnace body to blow wind:
a wind passing member which is placed inside the furnace body, which is opposed to said blowing apparatus, and through which the wind passes;
a heating apparatus which is placed inside said furnace body, and which heats at least one of the gas taken in by said blowing apparatus, and wind that has not yet entered said wind passing member; and
a rack which is placed inside said furnace body and in a circumference of said wind passing member, and which rotates around said wind passing member, wherein
said wind passing member has:
a cylindrical portion having an entrance port through which the wind enters, and rack-opposing flow-out ports which are opposed to said rack, and through which the wind flows out; and
wind guiding portions which are attached to said cylindrical portion, and which block part of the wind flowing along an inner circumferential surface of said cylindrical portion, to guide the wind to the rack-opposing flow-out ports.

2. The heat treatment furnace according to claim 1, wherein said wind guiding portions have:
a wind receiving surface which receives the wind; and
an outlet inner surface which contacts with said wind receiving surface,
at least a part of said wind receiving surface is placed inside said cylindrical portion, and
at least a part of said outlet inner surface is placed inside said rack-opposing flow-out port.

3. The heat treatment furnace according to claim 2, wherein an end of said outlet inner surface reaches an outside of said cylindrical portion.

4. The heat treatment furnace according to claim 1, wherein said wind guiding portions have a wind receiving surface which is placed inside said cylindrical portion, and which receives the wind, and
said wind receiving surfaces contact with inner circumferential surfaces of said rack-opposing flow-out ports.

5. The heat treatment furnace according to claim 1, wherein said rack has a plurality of rack plates which are placed so as to constitute a layered structure,
said rack plates have air permeability,
said cylindrical portion has a plurality of rack-opposing flow-out ports,
said cylindrical portion further has a hearth-opposing flow-out port which is opposed to said hearth through a gap,
said wind passing member has said plurality of wind guiding portions,
said plurality of rack-opposing flow-out ports are placed so as to be arranged in a layered direction of said rack plates, and,
among said plurality of rack plates, a rack plate which is closest to said hearth is opposed to said hearth.

6. The heat treatment furnace according to claim 5, wherein one of said rack-opposing flow-out ports is placed at a position which is between rack plates that are adjacent to each other, and which is closer to a rack plate of said rack plates that are adjacent to each other, said rack plate being remoter from said hearth, than a rack that is closer to said hearth.

7. The heat treatment furnace according to claim 5, wherein a distance between one of said rack-opposing flow-out ports and said blowing apparatus is shorter than a distance between a contrast object flow-out port which is one of other rack-opposing flow-out ports, and said blowing apparatus, and said one rack-opposing flow-out port is smaller than said contrast object flow-out port.
